(19) United States
(12) Patent Application Publication
(10) Pub. No.: US 2017/0038960 A1
(43) Pub. Date: Feb. 9, 2017

(54) MANAGEMENT OF DATA IN AN ELECTRONIC DEVICE

(71) Applicant: YOUR VOICE USA CORP., New York, NY (US)

(72) Inventors: Roberto Piroddi, Milano (IT); Paolo Siligoni, Milano (IT); Luca Agostini, Milano (IT)

(21) Appl. No.: 14/821,347

(22) Filed: Aug. 7, 2015

(51) Int. Cl. G06F 3/0488; G06F 3/0486; G06F 3/0482

(52) U.S. Cl. CPC G06F 3/04883; G06F 3/0482; G06F 3/0486

(57) ABSTRACT

An electronic device (1) includes: a touch-screen display (10); a processing unit (30) configured to: cooperate with the touch screen display (10) for displaying in a determined position (P1) on the display (10) a first item (X) associated to a first entity (E1); cooperate with the touch screen display (10) for displaying on the display (10) secondary items (Y) associated to respective entities (EY); cooperate with the touch-screen display (10) to detect a gesture (G) applied by a user to one or more of the secondary items (Y); upon recognition of the gesture (G), cooperate with the display (10) to replace the first item (X) with a determined secondary item of the one or more secondary items on which the gesture (G) has been applied.

### BACKGROUND OF THE INVENTION

1. Field of the Invention

The present invention refers to the management of data in an electronic device.

2. State of the Art

As known, mobile phones, especially the so called smart phones, are provided with storage, processing and connection capabilities which allow the management of information/data by means of different channels and different technologies, involving different contacts, external devices, etc.

The Applicant has noted that currently no tools are available that permit management of data in an easy, reliable and intuitive way.

### SUMMARY OF THE INVENTION

It is an object of the present invention to provide an easy, user-friendly and reliable way to manage data available to an electronic device provided touch screen capabilities, and in particular by a smart phone or tablet.

Another object of the present invention is to provide a fancy and intuitive way to manage data available to an electronic device provided with touch screen capabilities, through which the user can easily handle data and/or connections.

These and other objects are substantially achieved by an electronic device according to the present invention.

### BRIEF DESCRIPTION OF THE DRAWINGS

Further features and advantages will become more apparent from the detailed description of preferred and non-exclusive embodiments of the invention. The description is provided hereinafter with reference to the attached drawings, which are presented by way of non-limiting example, wherein:

FIGS. 1 to 11 schematically show possible embodiments of the invention;

FIGS. 12a-12e show block diagrams of possible embodiments of the invention;

FIGS. 13-15 schematically show data used in the invention.

### DETAILED DESCRIPTION OF THE INVENTION

In the accompanying drawings reference numeral 1 indicates an electronic device according to the present invention.

The electronic device 1 is preferably a portable or mobile device. For example the electronic device 1 can be a mobile phone, and in particular a so-called smart phone, or a tablet.

The electronic device 1 comprises a touch-screen display 10.

By means of the touch-screen capabilities of display 10, the device 1 is able to detect the position in which a user touches the display and the possible trajectory designed by the user moving his/her finger while it is in contact with the surface of the display.

Of course parts of the body other than fingers can be used, although fingers are the most commonly employed.

This touch-screen technology is per se well known and will not be disclosed in further detail.

The electronic device 1 comprises a processing unit 30. Preferably the processing unit 30 manages the overall functioning of the electronic device 1.

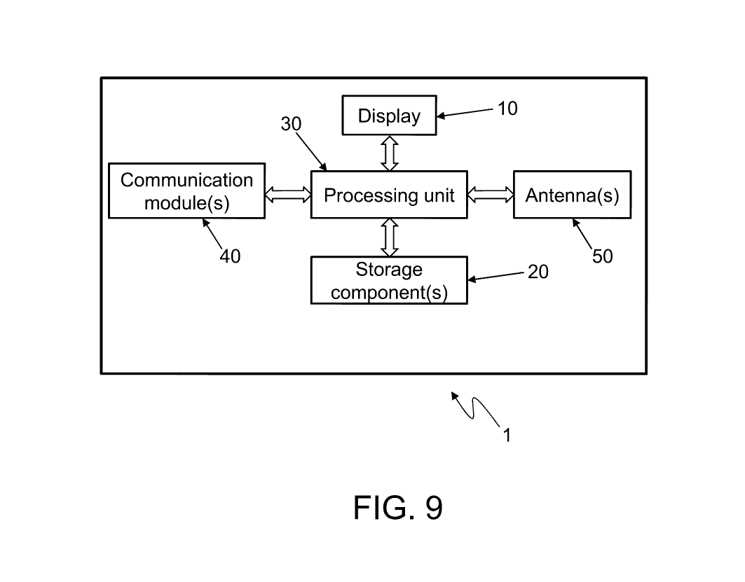

Preferably the processing unit 30 comprises (or coincides with) one or more microprocessors and/or one or more CPUs, suitably programmed so as to perform the operations herein disclosed. Such microprocessor(s) and/or CPUs are associated with one or more storage components 20, such as memories, in a manner per se known. The processing unit 30 is also preferably associated with one or more communication modules 40 and/or one or more antennas 50, so as to implement short range connectivity (e.g., Bluetooth® connectivity) and/or long range connectivity (e.g., GSM, GPRS, UMTS, LTE, LTA-A, etc.). Said storage component(s), communication module(s) and antenna(s) are advantageously included in the electronic device 1 (FIG. 9).

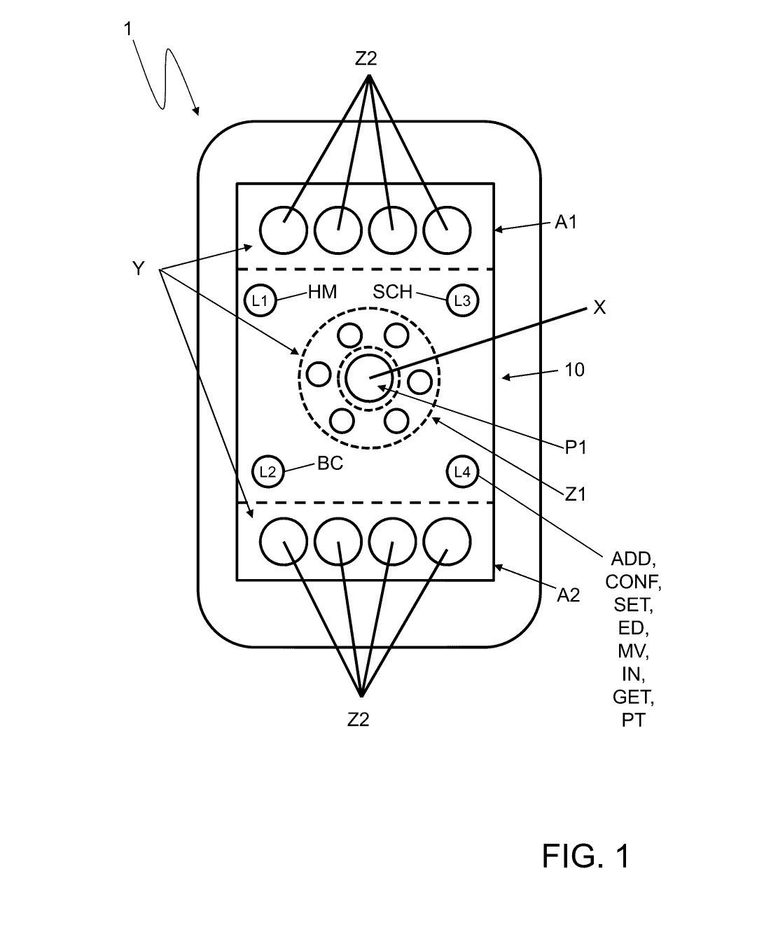

The processing unit 30 is configured to cooperate with the display 10 for displaying in a determined position P1 on said display 10 a first item X associated with a first entity E1 (FIG. 1).

The determined position P1 is preferably a substantially central position of said display 10.

For example the first item X can be an icon, a sign, a graphic symbol, a group of characters which is/are associated to the first entity E1 so that the user, when looking at the first item X, recalls the first entity E1.

The first entity E1 can be, for example, a person or an apparatus. The first entity E1 can also be a file, a set of data, a physical device, a virtual device, or any other item available to or accessible by said device 1. The first entity E1 can also be an application software program (so called “app”).

For example, when the device 1 is switched on, the first entity E1 can represent the same device 1.

For example, if the first entity E1 is the user, the first item X can be an avatar which pictorially represents the user, or an image chosen by the user to represent him/her-self.

The processing unit 30 is configured to cooperate with the display 10 for displaying on said display 10 secondary items Y associated to respective entities EY.

In general terms, the entities EY can be representative of data, information, containers of data, contents (documents, images, audio/video contents, etc.), commands, communication channels, virtual or physical devices (e.g., camera, wi-fi connection module, Bluetooth connection module, etc.), software programs (e.g., “apps”), etc.

For example each secondary item Y can be an icon, a sign, a graphic symbol, a group of characters which is/are associated to the respective entity EY so that the user, when looking at a secondary item Y, recalls the respective entity EY.

Preferably, the secondary items Y comprise surrounding items Z1 and peripheral items Z2.

Preferably the surrounding items Z1 are arranged around the first item X. For Example, the surrounding items Z1 can be arranged along a substantially circular line (which can be shown or imaginary) around the first item X.

Preferably the surrounding items Z1 are representative of data, information, containers of data (e.g., folders), contents (documents, images, audio/video contents, etc.), commands, communication channels, virtual or physical device (e.g., camera, wi-fl connection module, Bluetooth® connection module, etc.).

In addition or as an alternative, the secondary items Y preferably comprise peripheral items Z2.

Preferably the peripheral items Z2 are arranged in at least one of an upper area A1 and a lower area A2 of the display 10.

Preferably, the peripheral items Z2 are arranged in both the upper area A1 and the lower area A2 of the display 10.

For example, the peripheral items Z2 can be horizontally aligned, in one or more rows, in the upper area A1 and/or the lower area A2 of the display 10.

Preferably, the peripheral items Z2 are representative of virtual and/or physical devices, application software programs (“apps”), etc.

In the preferred embodiment, the peripheral items Z2 of the upper area A1 are representative of virtual and/or physical devices, whereas the peripheral items Z2 of the lower area A2 are representative of application software programs (“apps”).

It is to be noted that the expression “substantially central position” can include:

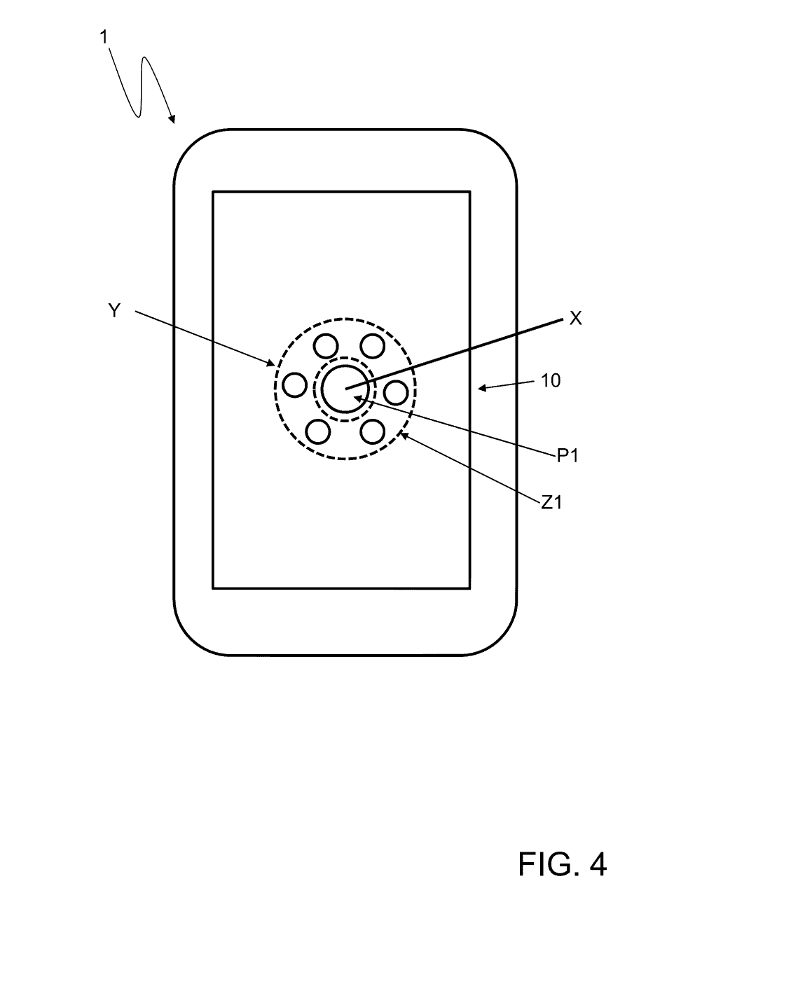

a position corresponding to the geometrical center of the display 10 (FIGS. 1 and 4);

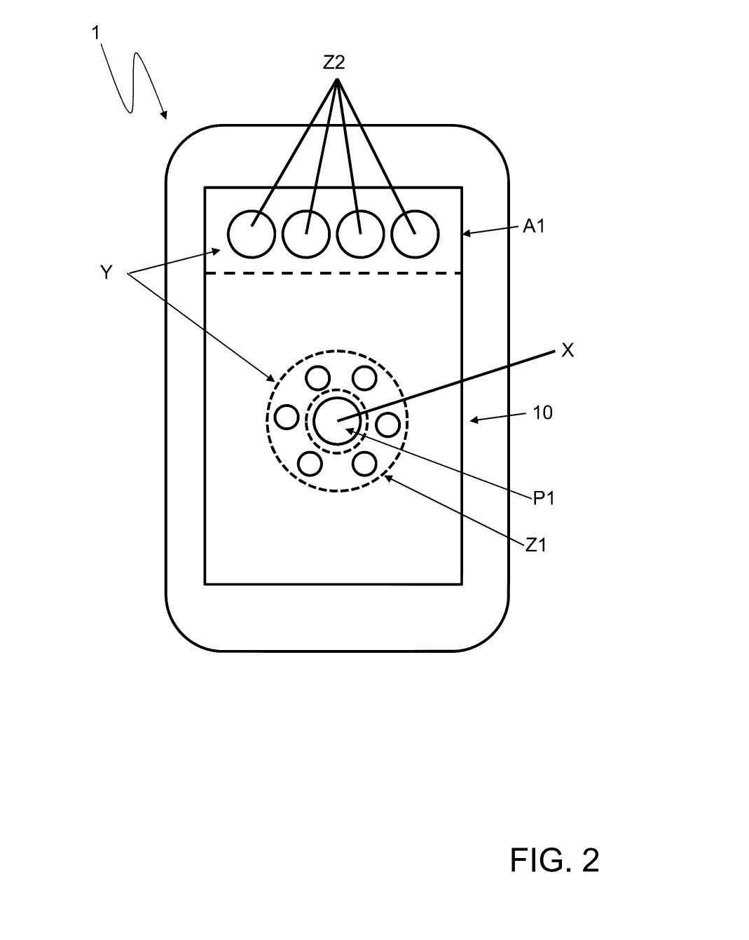

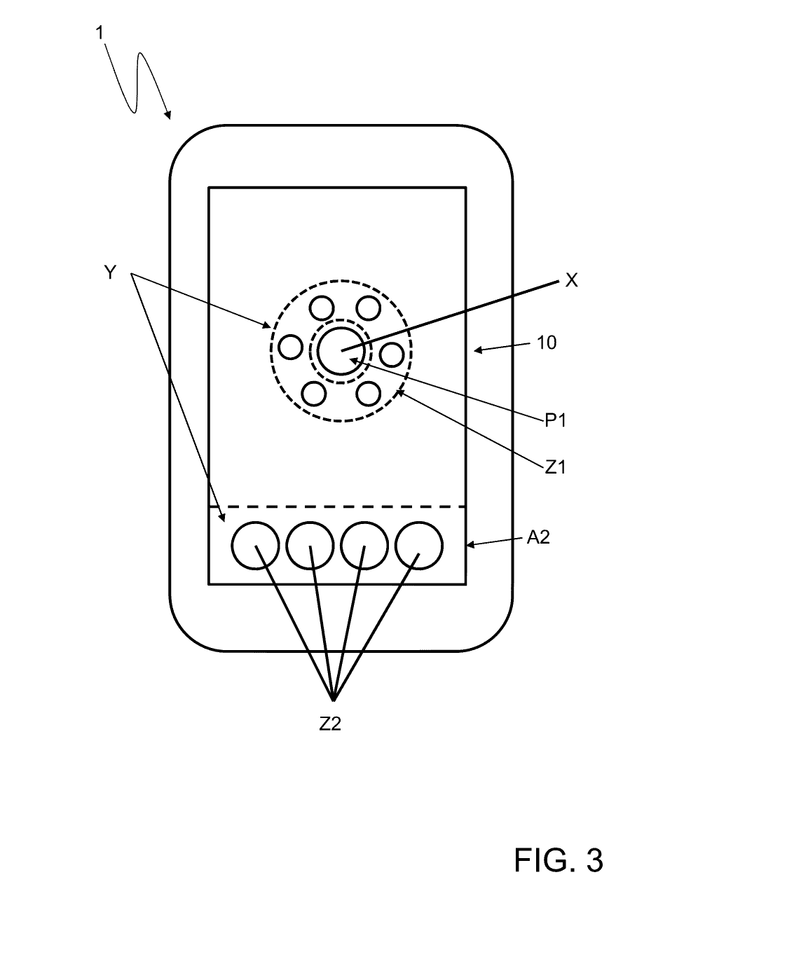

a position corresponding to the geometrical center of the region obtained excluding, from the display 10, the upper area A1 and/or the lower area A2 (FIGS. 2 to 4).

Preferably, the secondary items Y include one or more icons which, in a manner per se know, can be tapped on by the user so as to activate a corresponding command and/or software (e.g., an app).

According to the invention, the processing unit 30 is configured to cooperate with the display 10 to detect a gesture G applied by a user to one or more secondary items Y.

The gesture G is recognized by the processing unit 30 cooperating with the touch-screen capabilities of the display 10.

Preferably the gesture G is a tap gesture. This means that the user touches the display 10 in a determined position, corresponding to the position of a secondary item, with a sufficient intensity. Accordingly, the touch can be detected by the display 10 and processing unit 30 and the position in which the display 10 is touched can be identified.

Preferably the gesture G is a drag gesture.

The drag gesture defines, on the display 10, a trajectory which starts in a first position, i.e., the position of one of said secondary items Y, and ends in a second position, i.e., the position of a different secondary item Y.

This means that the user touches the screen at the first position and, keeping the finger (or, in general, the involved part of his/her body) in contact with the display, moves said finger on the display, i.e., the user changes in time the position in which he/she is touching the screen, until the second position is reached.

In practical terms the trajectory of the drag gesture is defined by the substantially continuous sequence of positions in which, in time, the finger of the user contacts the touch-screen display 10 starting from the first position and ending in the second position.

Preferably the processing unit 30 is configured to cooperate with the display 10 for graphically representing the displacement of a replica of the secondary item Y from which the drag gesture starts, from the first position along the trajectory defined by the drag gesture while the same gesture is executed, so as to give the pictorial impression that said secondary item Y directly follows the displacement imparted by the user, as if it were dragged by the user's finger.

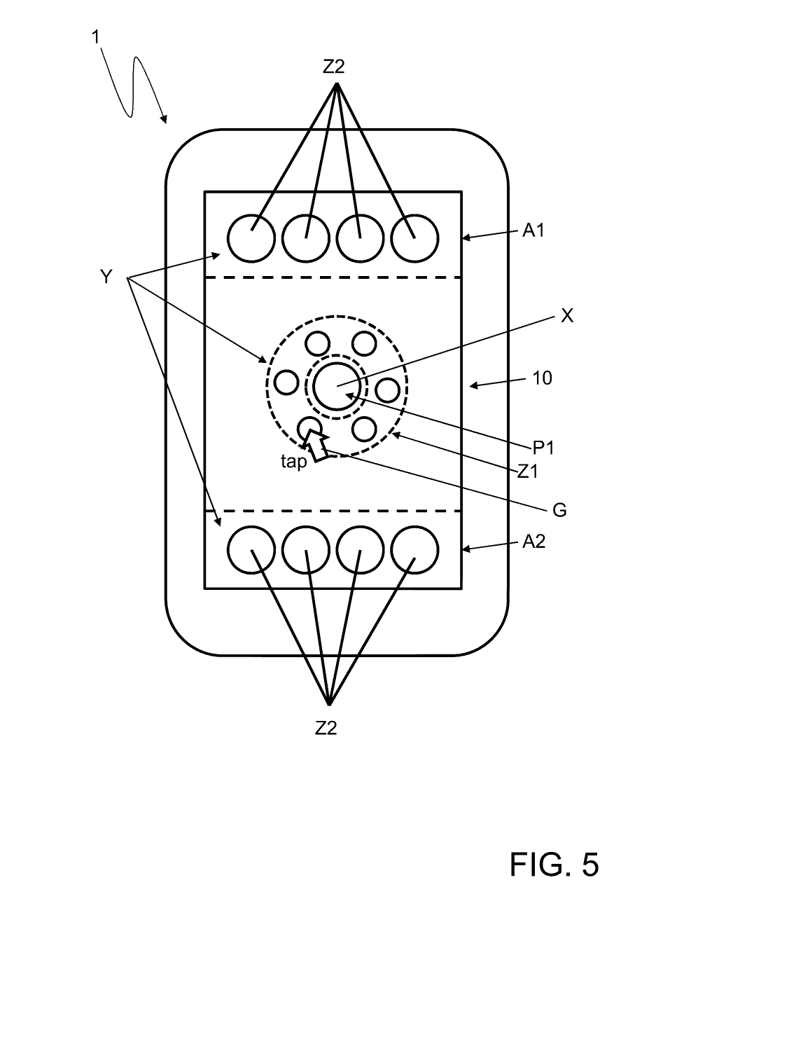

Preferably, the gesture G is a tap gesture applied to a surrounding item Z1 (FIG. 5).

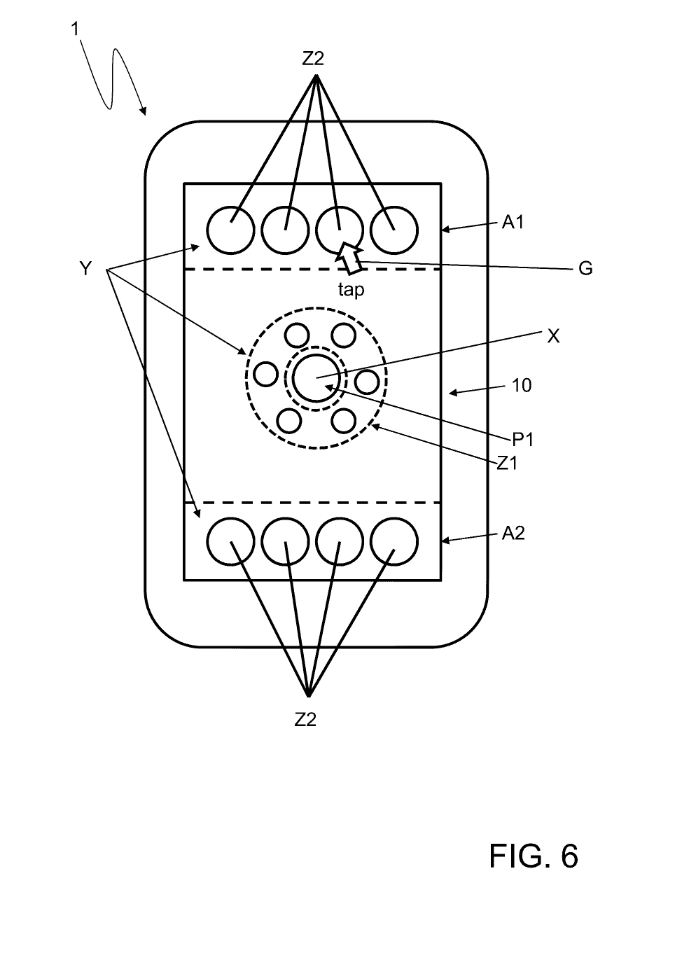

Preferably, the gesture G is a tap gesture applied to a peripheral item Z2 (FIG. 6).

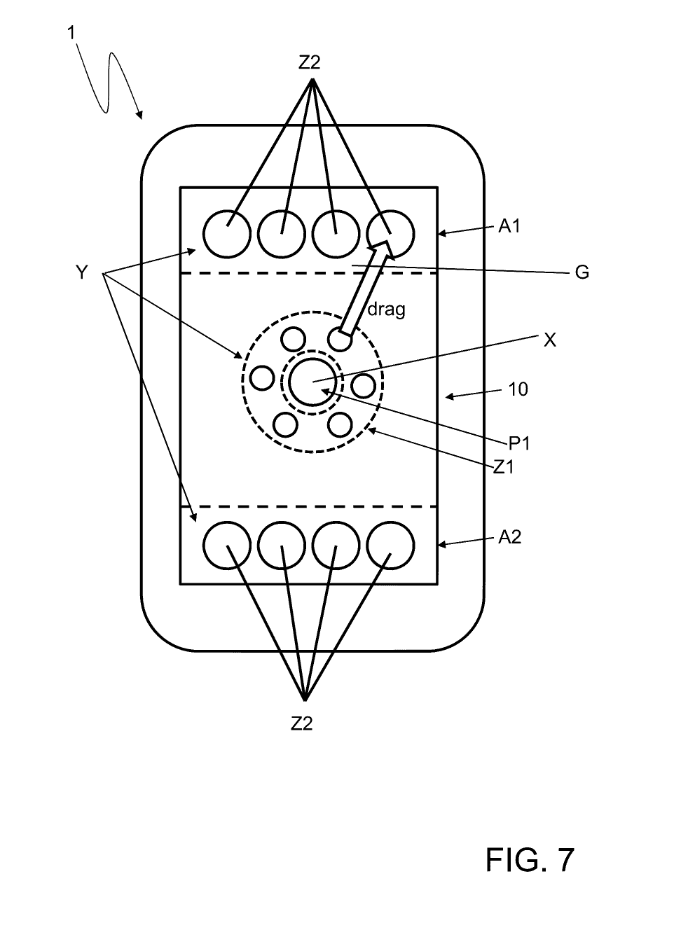

Preferably, the gesture G is a drag gesture from a surrounding item Z1 to a peripheral item Z2 (FIG. 7).

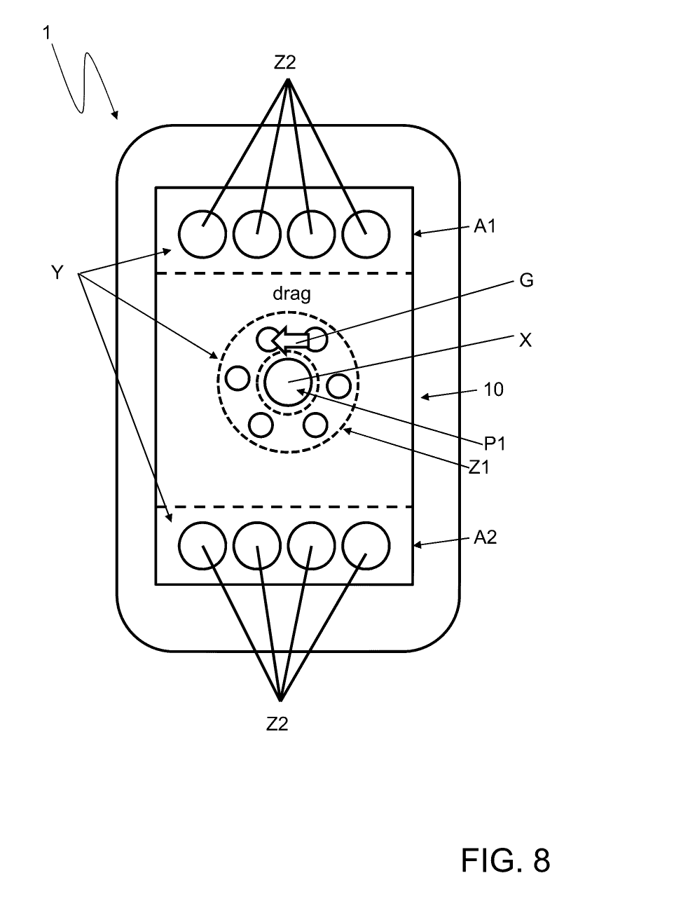

Preferably the gesture G is a drag gesture from a surrounding item Z1 to another surrounding item Z1 (FIG. 8).

The processing unit 30 is configured to replace, upon recognition of said gesture G, the first item X with a determined secondary item Y.

Preferably, the term “replace” is intended to mean that the first item X is deleted from the display 10 and, in the determined position P1, the determined secondary item is displayed instead.

The determined secondary item Y is one secondary item involved by the gesture G. In particular, the determined secondary item Y can be:

the surrounding item Z1 on which the tap gesture has been performed;

the peripheral item Z2 on which the tap gesture has been performed;

the surrounding item Z1 from which the trajectory of the drag gesture has started;

the peripheral item Z2 in which the trajectory of the drag gesture ends.

the surrounding item Z1 in which the trajectory of the drag gesture ends.

Preferably the electronic device 1 is associated with a main memory area MMA wherein main display information MDI is stored. For example, the main memory area MMA can be part of a physical memory installed in the device 1 and connected with the processing unit 30.

Preferably the main display information MDI is representative of the item to be displayed in the determined position P1 of the display 10.

Upon detection of the aforementioned gesture G, the main display information MDI is modified, so that a different item than the initial first item X is displayed in the determined position P1.

In particular, when the first item X is displayed in the determined position P1, the main memory area MMA includes first main display information representative of the same first item X. Upon detection of the gesture G, the processing unit 30 replaces the first main display information with second main display information, said second main display information being representative of the determined secondary item, i.e., the item that has to replace the first item X.

The processing unit 30 retrieves from the main memory area MMA the information regarding the item to be displayed in the determined position P1. As long as the main display information MDI is representative of the first item X, i.e., as long as the first main display information is stored in the main memory area MMA, the processing unit 30 will cooperate with the display 10 to display, in the determined position P1, the first item X. After the main display information MDI is changed into the second main display information, the processing unit 30 will cooperate with the display 10 to display, in the determined position P1, the determined secondary item.

Preferably the processing unit 30 is configured to cooperate with the display 10 to replace, upon detection of the gesture G, said surrounding items Z1 with different surrounding items. Advantageously, the different surrounding items are associated with the determined secondary item. In practice, before the gesture G is detected, the first item X is displayed in the determined position P1 and the surrounding items Z1 are arranged around the first item X; when the gesture G is detected, the first item X is replaced by the determined secondary item and the surrounding items Z1 are replaced by the surrounding items associated with said determined secondary item, i.e., by surrounding items representative of data, contents, actions, commands, folders, channels, etc., associated with the entity represented by the determined secondary item.

Advantageously, the processing unit 30 is associated with an auxiliary memory area AMA, wherein auxiliary display information ADI is stored. For example, the auxiliary memory area AMA can be part of a physical memory installed in the device 1 and connected with the processing unit 30. For example, the auxiliary memory area can be part of the same physical memory of which the main memory area MMA is part.

Preferably the auxiliary display information ADI is representative of the surrounding item(s) to be displayed around the item to be displayed in the determined position P1 of the display 10.

Upon detection of the aforementioned gesture G, the auxiliary display information ADI is modified, so that different items than the initial surrounding items Z1 are displayed around the determined position P1.

In particular, when the surrounding items Z1 are displayed around the determined position P1, the auxiliary memory area AMA includes first auxiliary display information representative of the same surrounding items Z1. Upon detection of the gesture G, the processing unit 30 replaces the first auxiliary display information with second auxiliary display information, said second auxiliary display information being representative of the new surrounding items to be displayed.

The processing unit 30 retrieves from the auxiliary memory area AMA the information regarding the items to be displayed around the determined position P1. As long as the auxiliary display information ADI is representative of the surrounding items Z1, i.e., as long as the first auxiliary display information is stored in the auxiliary memory area AMA, the processing unit 30 will cooperate with the display 10 to display, around the determined position P1, the surrounding items Z1. After the auxiliary display information ADI is changed into the second auxiliary display information, the processing unit 30 will cooperate with the display 10 to display, around the determined position P1, the new surrounding items.

For example, gesture G is a tap gesture applied to a peripheral item Z2 representing the addressbook stored in the device 1 (or in a virtual memory area associated thereto). Accordingly, such peripheral item is identified as the determined secondary item and the processing unit 30 cooperates with the display 10 so as to replace the current first item X with such determined secondary item. Also the surrounding items are replaced: the items surrounding the item representing the addressbook will be each representative of a respective contact included in the same addressbook.

For example, the gesture G is a drag gesture applied from a surrounding item Z1, representative of a certain content (e.g., an image) to a peripheral item Z2, representative of the addressbook stored in the device 1 (or in a virtual memory area associated thereto). Accordingly, the current first item X is replaced by the item representing the addressbook, and the new surrounding items will be representative of the contacts included in the addressbook. The user will then be able to tap on the new surrounding item(s) representative to the contact(s) with which he/she wants to share the content represented by the aforesaid surrounding item Z1. The user will also be prompted to select the channel and/or the software application through which the content has to be shared.

For example, the gesture G is applied from a surrounding item Z1, representative of a certain content (e.g., an image) to a peripheral item Z2, representative of cloud-based content storage software tool (e.g., Dropbox, Google Drive, etc.). Upon recognition of the gesture, the processing unit 30 cooperates with the display 10 to replace the first item X with an item representative of such software tool, surrounded by items representative of folders managed by the same software tool. By tapping on an item representative of a folder or a subfolder (see hereinafter), the user can select where the content has to be stored. In this case, the confirmation icon CONF (see below) can be used to confirm the selection of the destination folder/subfolder.

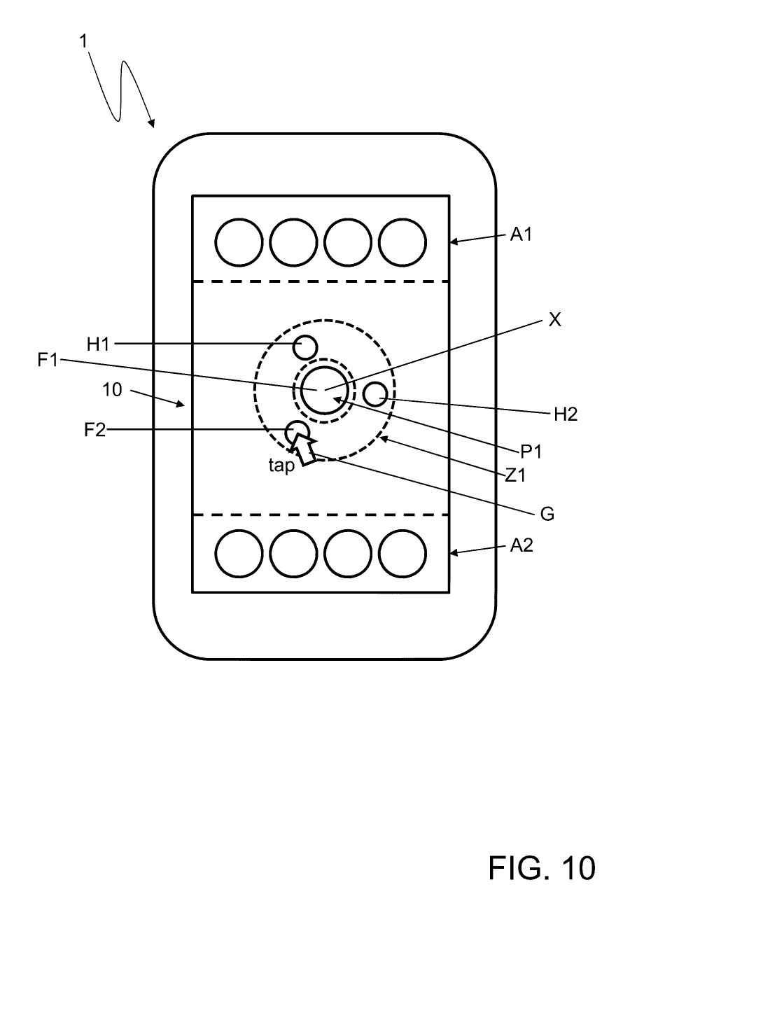

For example, the first item X can represent a main folder F1, and at least one of its surrounding items Z1 represent a subfolder F2 of the main folder F1 (FIG. 10).

Other surrounding items Z1 of the first item X can represent data, commands, contents, etc., associated with the main folder F1.

When the gesture G is executed, e.g., a tap gesture on the surrounding item Z1 representing the subfolder F2, the latter is identified as the determined secondary item, i.e., the item that has to replace the first item X.

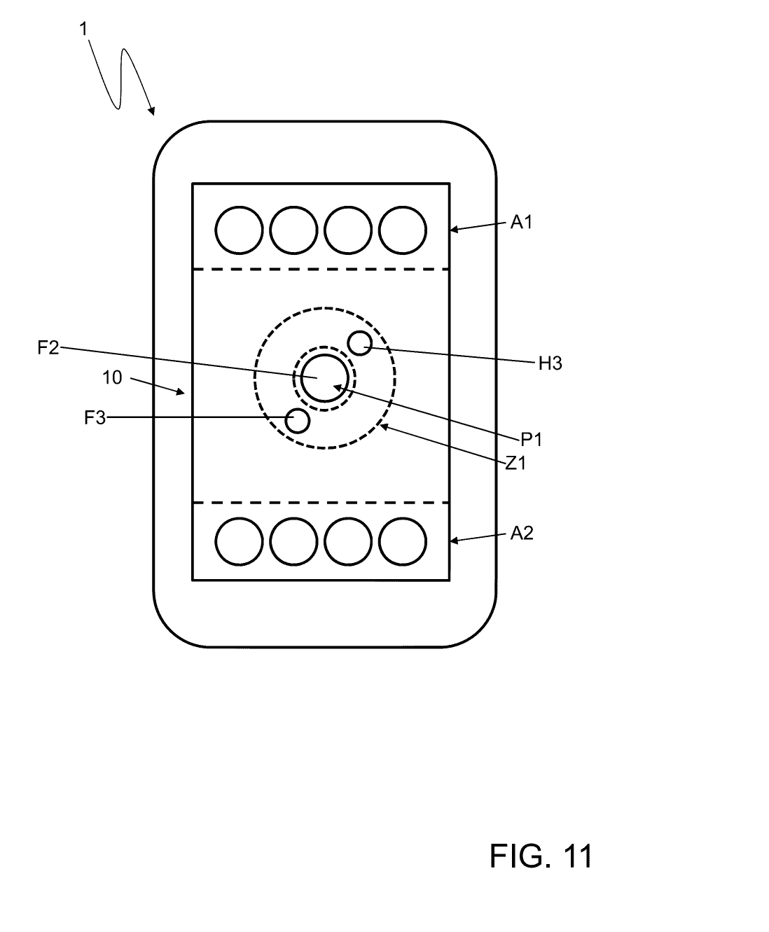

Accordingly, the processing unit 30 operates so that such surrounding item Z1 replaces the first item X in the determined position P1 (FIG. 11).

Preferably also the surrounding items are replaced: upon detection of the gesture G, the current surrounding items Z1 (associated with the first item X) are replaced by different surrounding items, associated with the determined secondary item. In practice, the new surrounding items will be representative of at least one of:

one or more subfolders of said subfolder F2;

data contained in the subfolder F2.

In a particularly simple example, the main folder F1 contains one subfolder (i.e., subfolder F2) and two files. Furthermore, subfolder F2 contains one subfolder F3 and one file.

Accordingly, the first item X represents the main folder F1 and is associated with three surrounding items (FIG. 10): one surrounding item is representative of the subfolder F2, and two surrounding items H1, H2 are representative of the two files, respectively.

If a tap gesture is executed on the item representative of the subfolder F2, such item will replace the first item X; the new surrounding items will include one item representative of the subfolder F3, and one item H3 representative of the filed contained in the subfolder F2 (FIG. 11).

If a tap gesture is applied to one of the items representative of files, the respective file will be opened.

Accordingly, a browsing system or navigation system adapted to explore data arranged in a multilevel structure can be implemented: by executing proper gestures, different levels of data can be easily displayed and accessed.

In more detail, in the storage component(s) 20 data can stored according to a logic tree-structure arrangement.

The tree-structure arrangement comprises a plurality of nodes, each node being associated with at least a different node according to a hierarchical relationship.

The top level node (level 0) can be considered the root of the tree-structure arrangement.

The bottom level node(s) (level N) can be considered the leaves of the tree-structure arrangement.

Each node can be representative, for example, of a folder or an element (e.g., a file) contained in a folder. A node can also represent a link or a reference to data physically stored in a different memory location, inside or outside the electronic device 1.

If a folder is at level k, its content (be it a subfolder or a file) is at level k+1.

Given a node at level j, the nodes associated thereto and belonging to the j+1 level can be referred to as subnodes of said node.

One or more nodes can also be representative of respective virtual or physical devices. The nodes associated with these nodes can be representative of actions/commands to be performed by such devices, data descriptive of such devices, options associates with such devices, etc.

It is to be noted that nodes at the same level are not necessarily directly associated with each other: in fact such nodes can be directly associated to different nodes belonging to the upper level and/or to different nodes belonging to the lower level.

The first item X displayed in the determined position P1 of the display 10 represents one of said nodes. The surrounding items Z1 represent the nodes at the immediately lower level in the tree-structure arrangement, which are associated with the node represented by the first item X.

Accordingly, the graphical representation on the display 10 shows a part of the tree-structure arrangement of the data stored in the memory 30, namely the part concerning the node represented by item X, which includes such node and the nodes at the immediately lower level and associated with such node.

By means of the gesture G (for example a tap gesture on one of the surrounding items Z1), the graphical representation on the display 10 is changed, and becomes representative of the node represented by the surrounding item Z1 on which the tap gesture has been executed, surrounded by items representative of nodes of the immediately lower level and associated thereto.

Preferably the storage component(s) 20 include the aforementioned main memory area MMA and auxiliary memory area AMA.

Accordingly, in the storage component(s) 20 are stored:

the above mentioned tree-structure arranged data, and

the above mentioned main display information MDI and auxiliary display information ADI.

When the user executes the gesture G, it means that he/she wants to display different data on the display 10; in particular, it means that he/she wants to change from the current node+subnodes to one of the subnodes+the respective subnodes of the lower level.

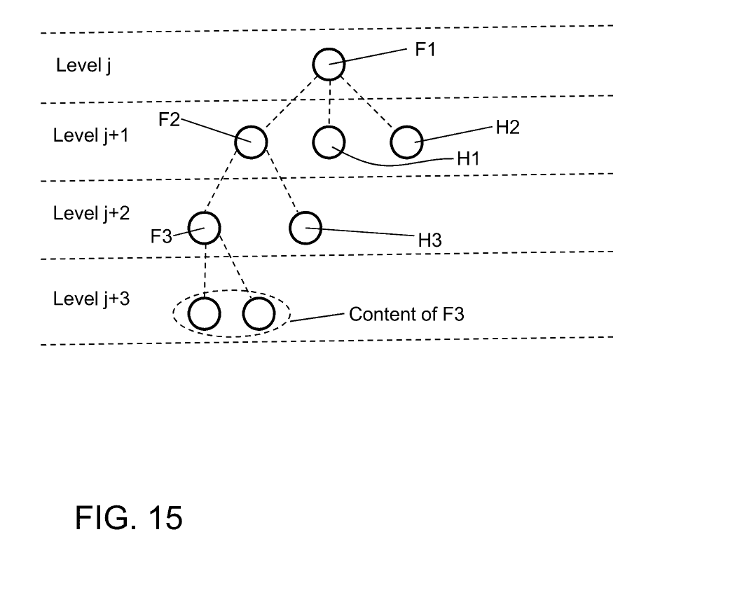

FIG. 15 schematically represents a tree-structure arrangement involving folders F1, F2, F3 and the content thereof. It is to be noted that this can be part of a larger and more complex data arrangement. The representation of FIG. 15 is provided by way of example in order to further explain some features disclosed herein. For example, folder F1 appears to be the root of the structure represented in FIG. 15; however, level j is not necessarily level 0 and, as said, can correspond to any part of a larger data structure. For example, other nodes can be present at level j, which are not represented for the sake of simplicity.

Referring to FIG. 15, when the first item X is representative of folder F1, which belongs to level j, the surrounding items Z1 are representative of the relevant nodes of level j+1, namely subfolder F2 and files H1, H2. When, following gesture G, folder F2 replaces folder F1 in the determined position P1 on display 10, the surrounding items are replaced by new surrounding items representing the relevant nodes belonging to level j+2.

It is to be noted that FIG. 15 refers to folders merely by way of example; as said, the nodes can be representative of different kind of entities (devices, apps, communication channels, audio/video contents, data, options, commands, etc.).

As a consequence, the main display information MDI in the main memory area MMA and preferably the auxiliary display information ADI in the auxiliary memory area AMA are modified, and the representation on the display 10 updated accordingly.

Preferably, the processing unit 30 is configured to cooperate with the display 10 for displaying one or more functional items L1-L4 on the display 10 (FIG. 1).

Preferably the functional items L1-L4 are part of the secondary items Y.

Preferably, each functional item L1-L4 is located at a respective corner of the central part of the display 10, i.e., the part not occupied by the upper and/or lower areas A1, A2.

It has to be noted, however, that the functional items L1-L4 can be arranged in any other suitable position on the display 10.

When a tap gesture is applied on one functional item L1-L4, a respective action/command is executed.

Preferably, one of the functional items L1-L4 is a home icon HM. When a tap gesture is applied to the home icon HM, the browsing/navigation will be directly brought to the root of the tree-structure data arrangement, or to a predetermined node of the data structure, which is conveniently identified, beforehand, as the point from which navigation/browsing has to start. For example, such initial node can be the electronic device 1. Accordingly, the graphical representation on the display 10 is modified: when the home icon HM receives a tap gesture, the first item X representative of the initial node (e.g., the electronic device 1 itself) will be displayed in the determined position P1, and the relevant surrounding items Z1 will be displayed around the first item X.

Preferably, one of the functional items L1-L4 is a back icon BC.

When a tap gesture is applied to the back icon BC, the navigation/browsing will be directly brought to the previous node.

For example: the item representative of the folder F1 is displayed in the determined position P1, and the item representative of the folder F2 is displayed as surrounding item Z1; a tap gesture is applied on the item representative of the folder F2, so that the item representative of the folder F1 is replaced, in the determined position P1, by the item representative of the folder F2; at this point, if the back icon BC receives a tap gesture, the display will be brought back to the previous situation, in which the item representative of the folder F1 is displayed in the determined position P1, and the item representative of the folder F2 is displayed as surrounding item Z1.

Preferably, one of the functional items L1-L4 is a search icon SCH.

When a tap gesture is applied to the search icon SCH, the processing unit 30 cooperates with the display 10 to display a search mask or menu, to prompt the user to insert the string to be searched and possible additional search options. The search can be carried out, for example, among contents stored in the device 1 (e.g., in the storage components 20 or in specific memory areas included therein) or on the internet, exploiting the connection capability provided by the communication modules 40 and/or antennas 50.

Preferably, one of the functional items L1-L4 is an addition icon ADD. When a tap gesture is applied to the addition icon ADD, the processing unit 30 cooperates with the display 10 for displaying a dialogue mask to allow the user to insert a new element in the current context. For example, a new subfolder can be added to the current folder represented by the first item X. Accordingly, the user is prompted to insert, for example, the name of the new subfolder.

Preferably, one of the functional items L1-L4 is a confirmation icon CONF. When a tap gesture is applied to the confirmation icon CONF, the processing unit 30 executes an action which was not finalized and needed the user's final OK.

Preferably, one of the functional items L1-L4 is a setting icon SET. When a tap gesture is applied to the setting icon SET, the processing unit 30 executes a corresponding action and/or cooperates with the display 10 to display a set up menu preferably associated to the current context.

Preferably, one of the functional items L1-L4 is an edit icon ED. When a tap gesture is applied to the edit icon ED, the processing unit 30 allows the user to edit a previously selected item or piece of data.

Preferably, one of the functional items L1-L4 is a move icon MV. When a tap gesture is applied to the move icon MV, the processing unit 30 allows the user to move (i.e., copy, paste, etc.) previously selected item or piece of data from a memory location (virtual or physical) to a different one.

Preferably, one of the functional items L1-L4 is an info icon IN. When a tap gesture is applied to the info icon IN, the processing unit 30 cooperates with the display 10 to show details concerning a previously selected item or piece of data.

Preferably, one of the functional items L1-L4 is a get icon GET. When a tap gesture is applied to the get icon GET, the processing unit 30 allows the device 1 to request data to a server preferably remotely connected to the same device 1.

Preferably, one of the functional items L1-L4 is a post icon PT. When a tap gesture is applied to the post icon PT, the processing unit 30 allows the device 1 to send data to a server preferably remotely connected to the same device 1

In the preferred embodiment, four functional items L1-L4 are displayed on display 10. Depending on the context, the addition icon ADD can be replaced by one of the CONF, SET, ED, MV, IN, GET, PT icons. It has to be noted, however, that also other arrangements of the functional items L1-L4 are envisaged.

For example, the first item X can be representative of the electronic device 1 and one of the surrounding items Z1 can be representative of a virtual or a physical device—such as a camera integrated in the same device 1.

Accordingly, if a tap gesture is applied to such surrounding item, the first item X representative of the device 1 is replaced by the item representative of the virtual or physical device.

In this case, the respective new surrounding items will be representative of at least one of:

data associated with said virtual or physical device;

one or more actions associated with said virtual or physical device.

For example, in the case of a camera, one surrounding item can be representative of a command for having such camera take a picture. Other surrounding items can represent, for example, options associated with the camera and/or the action of taking pictures: flash on/off, color or greyscale, virtual optical filters, etc. By tapping on such surrounding items, corresponding actions are caused: set up of particular features of the camera, taking of a picture, etc.

In general terms, the surrounding items Z1 can include both items that, when involved by the gesture G, can cause the replacement of the first item X, and items that are conventionally associated to the respective entity, so that when a tap gesture is applied to such items, a corresponding action (i.e., activation of an “app”) is caused by the processing unit 30.

Preferably, the processing unit 30 is configured to cooperate with the display 10 to detect a tap gesture applied to the first item X.

Upon detection of such tap gesture, the peripheral items Z1 are replaced with one or more additional items Z3, while maintaining the first item X displayed in the determined position P1.

The additional items Z3 are associated with the first item X, i.e., the additional items Z3 are representative of data, contents, channels, actions, commands, options, etc., associated with the first entity E1.

This features is particularly useful when the first item X (i.e., the first entity E1) is associated with a number of commands, folders, pieces of data, options, etc., such that all the corresponding surrounding items cannot be displayed simultaneously on the display 10. In other words, there would be too many surrounding items and the graphical representation on the display 10 would not be efficiently and/or reliably usable by the user.

Accordingly, a threshold is set (for example equal to 4, 5 or 6) for the maximum number of surrounding items that can be displayed, in a single moment, on the display 10.

In case the surrounding items associated with the first item X is higher than said threshold, then the surrounding items are divided in two or more groups, each group including a number of items equal or smaller than the threshold. A first group of surrounding items will be initially displayed; then, following a tap gesture on the first item, a second group will replace the first group, and so on. As said, while showing different groups of surrounding items, in this case the first item X remains displayed in the determined position P1.

Accordingly, all the subfolders/option/commands/actions/files/pieces of data associated with the first item X can be sequentially browsed, in a simple and intuitive way.

In a preferred embodiment, the processing unit 30 is configured to cooperate with the display 10 for detecting a tap gesture applied to a secondary item Y, said secondary item being representative of data or a piece of data. For example, such secondary item can be a surrounding item Z1. Upon recognition of such tap gesture, the processing unit 30 cooperates with the display 10 to display additional information related to said data or piece of data. For example, a small window or pop-up can be displayed, as if the area dedicated to the initial piece of data is expanded, and the additional data is inserted in the small window or pop-up.

In a preferred embodiment, the processing unit 30 is configured to cooperate with the display 10 for detecting a drag gesture applied by a user from a first surrounding item Z1 to a second surrounding item different from said first surrounding item. This drag gesture can be the aforementioned main gesture G or a different gesture, detected before or after said gesture G. Upon recognition of this drag gesture, an action can be triggered, such as for example moving the content of a folder represented by the first surrounding item into a folder represented by the second surrounding item.

In a preferred embodiment, the processing unit 30 is configured to cooperate with the display 10 for detecting a drag gesture applied by a user from a surrounding item Z1 to a peripheral item Z2. This drag gesture can be the above mentioned gesture G or a different gesture, detected before or after said gesture G. Upon recognition of such drag gesture, the processing unit 30 triggers an operation. This operation preferably comprises at least one of:

a transfer of information from a first memory area M1 associated with the first item X to a second memory area M2 associated with a second entity associated with the peripheral item Z2;

a command executed by an execution device, said execution device being associated with said second entity.

Preferably said command is executed based on data associated with the first item X.

It is to be noted that, from a general point of view, the term “command” used herein designates any action or operation that can be performed by the execution device upon reception of a suitable instruction.

Preferably, in case of a detection of a drag gesture, the operation that is executed is independent from a distance between the first position and the second position which define the beginning and the end, respectively, of the trajectory off the drag gesture. In other terms, the operation is determined based on the “meaning” of (i.e., on the data/information associated with) the involved items, irrespective of the distance therebetween.

In one embodiment, the first memory area M1 is embedded in the electronic device 1. As an alternative, the first memory area M1 is located outside the electronic device 1 and is connected to the electronic device 1 by means of a wireless and/or remote connection. For example, the first memory area M1 can be embedded in a server apparatus, remotely connected to the electronic device 1.

In one embodiment, the second memory area M2 is embedded in the electronic device 1. As an alternative, the second memory area M2 is located outside the electronic device 1 and is connected to the electronic device 1 by means of a wireless and/or remote connection. For example, the second memory area M2 can be embedded in a server apparatus, remotely connected to the electronic device 1.

In view of the above, the transfer of information can be carried out according to four different schemes:

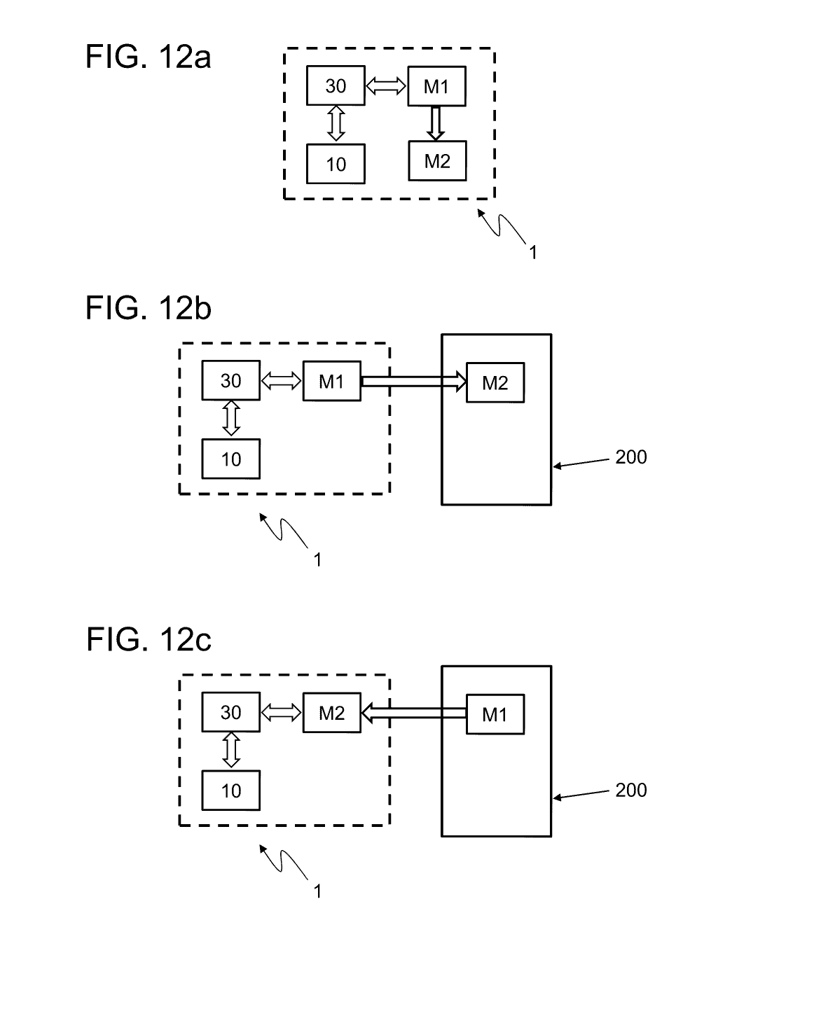

a) from a memory area (first memory area M1) embedded in the electronic device 1 to a memory area (second memory area M2) embedded in the same electronic device 1 (FIG. 12a);

b) from a memory area (first memory area M1) embedded in the electronic device 1 to a memory area (second memory area M2) which is located outside the electronic device 1, for example a memory area of a remote server or a remote device 200 (FIG. 12b);

c) from a memory area (first memory area M1) which is located outside the electronic device 1, for example a memory area of a remote server or a remote device 200 to a memory area (second memory area M2) embedded in the electronic device 1 (FIG. 12c);

d) from a memory area (first memory area M1) which is located outside the electronic device 1, for example a memory area of a remote server or a remote device, to a memory area (second memory area M2) which is located outside the electronic device 1, for example a memory area of a remote server or a remote device. In this case, the first and second memory areas M1, M2 can be included in the same apparatus 200 (FIG. 12d), or can be included in distinct apparatuses 200, 200′ (FIG. 12e).

It is to be noted that the mentioned memory areas can be any type of physical or virtual memory associated with respective device or apparatus.

It is to be noted that the information/data transferred from the first memory area M1 to the second memory area M2 can comprise any type of information/data in electronic format, such as for example documents (editable/non-editable), audio/video files, images, pieces of software, email messages, chat messages, attachments, etc.

In one embodiment, the execution device and the electronic device 1 are the same device. This means that the command triggered by the drag gesture is executed by the same electronic device 1. As an alternative, the execution device can be an apparatus other than the electronic device 1. This means that the drag gesture triggers the transmission to the execution device of a suitable instruction signal so as to have the latter execute the desired command.

For example, a drag gesture can be applied to a surrounding item Z1 representative of the geographical position of the device 1 (determined for example by a GPS positioning module included in the same device 1) to a peripheral item Z2 representative of a software (e.g., an app) implementing a social network. The position of the device will then be automatically shared with the contacts associated to the used through such social network. In practical terms, a signal will be sent, preferably through a long range connection based on the aforementioned communication module(s) 40 and/or antenna(s) 50, to a remote server which manages the social network; the signal includes at least data indicative of the user's account (said data being stored in a local memory area of the device 1) and the position to be shared. The remote server will update the user's profile by adding information concerning the position.

It is to be noted that the functions disclosed here above can be carried out based on the structure summarized hereinafter.

The processing unit 30 is preferably associated to a physical or virtual memory, in which portions/positions of the display 10 are associated with data graphically represented by the items displayed in said portions/positions.

Once the gesture G is detected, the data associated to the item(s) to which the gesture G is applied are identified and the proper action is performed based on such identified data.

In particular, the action can be a modification of the content of said physical or virtual memory. In fact, when the first item X is replaced by the determined secondary item, the data associated with the determined position P1 of the display 10 is modified: before the gesture G is detected, the determined position P1 is associated, in said physical or virtual memory, with data represented by the first item X; after the gesture G is detected, the determined position P1 in said physical or virtual memory will be associated to the data represented by the determined secondary item. The same applies to the replacement of the surrounding items and data associated thereto.

It is to be noted that the aforementioned main memory area MMA and auxiliary memory area AMA can be included in or associated to said physical or virtual memory.

In view of the above, according to the present invention a certain item (and the data associated thereto) can cause different a different action/operation based on the position in which such item is arranged on the display 10. For example, in case the item represents a folder:

if the item is a surrounding item (i.e., it is arranged in a position around the determined position P1), then a tap gesture applied to such item will cause the same item to be displayed in the determined position P1, replacing the current first item X; the subfolders and/or files or other contents of the folder will be represented by new surrounding items which replace the surrounding items Z1 associated with the first item X;

if the item is the first item X (i.e., it is displayed in the determined position P1), then a tao gesture applied to such item can cause the replacement of the current surrounding items with a different group of surrounding items, maintaining the same first item in the determined position P1.

Preferably, an indication of the navigation/browsing page currently displayed (e.g., 1 of 3; 2 of 3, . . . ), each corresponding to a respective group of surrounding items, can be displayed on the display 10.

It is to be noted that the cooperation between the processing unit 30 and the display 10 is based on an exchange of signals: preferably the display 10 sends to the processing unit 30 signals representative of the physical actions, i.e., the gestures, applied on the same display 10, so that the processing unit 30 can detect/recognize such gestures and cause corresponding actions; preferably, the processing unit 30 sends to the display 10 signals representative to the graphical elements (i.e., the items) to be displayed, in respective positions, on the display 10.

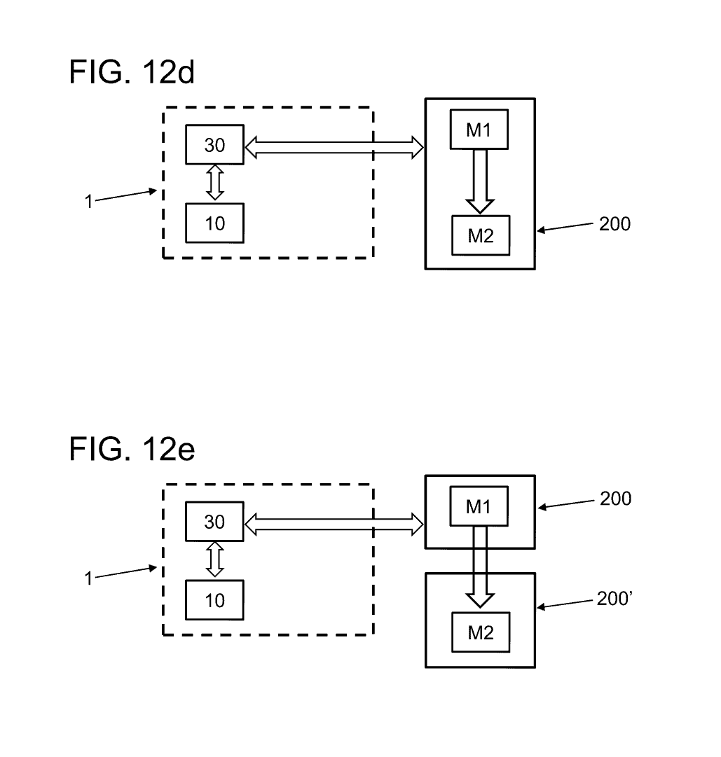

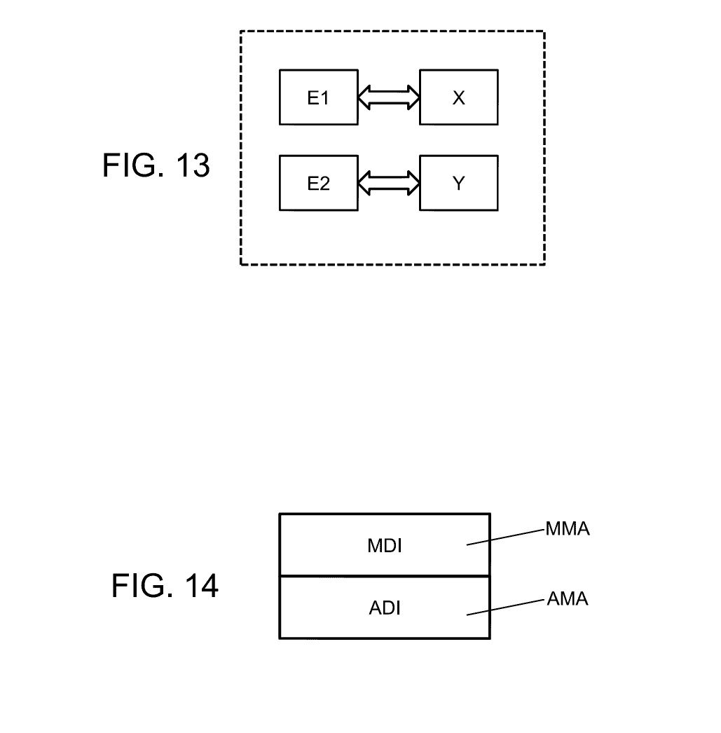

FIG. 13 show the logic connection between entities E1, E2 and the respective graphical representations provided by items X, Y. This logic connection is stored in a suitable memory area associated to the processing unit 30.

In order to perform the functions disclosed here above, the processing unit 30 is suitably programmed, i.e., a software program is executed by the processing unit 30. Such software program can be stored in the aforementioned storage component(s) 20 or in a different memory associated with the processing unit 30. The software program can be natively installed in the electronic device 1, or it can be installed later. In the latter case, such software program can be in the form of an “app”, which can be downloaded through internet from a remote server providing such software. In order to download the software program, the electronic device 1 can advantageously employ the aforementioned communication module(s) and/or antenna(s) so as to establish a short or long range connection with said server.

The invention achieves important advantages.

Firstly the invention provides an easy, user-friendly and reliable way to manage data, information processing and exchange in an electronic device provided with touch-screen capabilities, and in particular in a smart phone or tablet.

Furthermore, the invention provides a fancy and intuitive way to manage data accessible by an electronic device provided with touch screen capabilities, through which the user can easily handle large amounts of data.

What is claimed is:

1. An electronic device comprising:
a touch-screen display;
a processing unit configured to:
cooperate with said touch screen display for displaying in a determined position on said display a first item associated to a first entity;
cooperate with said touch screen display for displaying on said display secondary items associated to respective entities;
cooperate with said touch-screen display to detect a gesture applied by a user to one or more of said secondary items;
upon recognition of said gesture, cooperate with said display to replace said first item with a determined secondary item of said one or more secondary items on which said gesture has been applied.

2. The electronic device according to claim 1, wherein said electronic device is associated with a main memory area wherein display information is stored, said display information being representative of the item to be displayed in said determined position of said display, wherein said processing unit is configured to modify, upon detection of said gesture, said display information.

3. The electronic device according to claim 2, wherein:
when said first item is displayed in said determined position, said main memory area includes first display information representative of said first item; and
said processing unit is configured to replace, upon detection of said gesture, said first display information with second display information, said second display information being representative of said determined secondary item.

4. The electronic device according to claim 1, wherein said gesture comprises a tap gesture applied to said secondary item, wherein said processing unit is configured to cooperate with said display, upon recognition of said tap gesture, to replace said first item with said determined secondary item.

5. The electronic device according to claim 1, wherein said secondary items comprise surrounding items and peripheral items, said surrounding items being arranged around said first item, said peripheral items being arranged in at least one of an upper area and a lower area of said display.

6. The electronic device according to claim 5, wherein said gesture comprises a drag gesture from a determined surrounding item to a determined peripheral item, wherein said processing unit is configured to cooperate with said display, upon recognition of said drag gesture, to replace said first item with said determined peripheral item.

7. The electronic device according to claim 5, wherein said processing unit is configured to cooperate with said display to replace, upon detection of said gesture, said surrounding items with surrounding items associated with said determined secondary item.

8. The electronic device according to claim 7, wherein:
said first item is representative of a main folder of data;
at least one of said surrounding items is representative of a subfolder of said main folder;
said at least one of said surrounding items is said determined secondary item;
said processing unit is configured to replace, upon detection of said gesture, said surrounding items with surrounding items representative of at least one of:
one or more subfolders of said subfolder;
data contained in said subfolder.

9. The electronic device according to claim 7, wherein:
at least one of said surrounding items is representative of a virtual or physical device;
said at least one of said surrounding items is said determined secondary item;
said processing unit is configured to replace, upon detection of said gesture, said surrounding items with surrounding items representative of at least one of:
data associated with said virtual or physical device;
one or more actions associated with said virtual or physical device.

10. The electronic device according to claim 5, wherein said processing unit is configured to cooperate with said display to:
detect a tap gesture applied to said first item;
upon detection of said tap gesture, replace said peripheral items with one or more additional items, while maintaining said first item displayed in said determined position.

11. The electronic device according to claim 1, wherein said processing unit is configured to cooperate with said display to:
detect a tap gesture applied to a secondary item representative of data;
upon detection of said tap gesture, display additional information related to said data.

12. The electronic device according to claim 5, wherein said processing unit is configured to cooperate with said display to:
detect a drag gesture applied by a user from a surrounding item to a peripheral item;
upon recognition of said gesture, trigger an operation,
wherein said operation comprises at least one of:
a transfer of information from a first memory area associated with said first item to a second memory area associated with a second entity associated with said peripheral item;
a command executed by an execution device, said execution device being associated with said second entity.

13. The electronic device according to claim 12, wherein said command is executed based on data associated with said first item.

14. A method comprising:
operating a processing unit and a touch-screen display of an electronic device for displaying in a determined position on said display a first item associated to a first entity;
operating said processing unit and said touch-screen display for displaying on said display secondary items associated to respective entities;
operating said processing unit and said touch-screen display to detect a gesture applied by a user to one or more of said secondary items;
upon recognition of said gesture, operating said processing unit and said touch-screen display to replace said first item with a determined secondary item of said one or more secondary items on which said gesture has been applied.

15. A non-transitory computer readable storage medium storing one or more programs comprising instructions, which when executed by an electronic device cause the device to:
display in a determined position on said display a first item associated to a first entity;
display on said display secondary items associated to respective entities;
detect a gesture applied by a user to one or more of said secondary items;
replace, upon recognition of said gesture, said first item with a determined secondary item of said one or more secondary items on which said gesture has been applied.
